(19) United States
(12) Patent Application Publication
(10) Pub. No.: US 2015/0088997 A1
(43) Pub. Date: Mar. 26, 2015

(54) Method and System for Tracking Estimated Cost of Events

(71) Applicants: Luuk Adriaan Cornelis van Dijk, Zurich (CH); Sascha Benjamin Brawer, Berne (CH)

(72) Inventors: Luuk Adriaan Cornelis van Dijk, Zurich (CH); Sascha Benjamin Brawer, Berne (CH)

(73) Assignee: Google Inc., Mountain View, CA (US)

(21) Appl. No.: 13/220,645

(22) Filed: Aug. 29, 2011

(51) Int. Cl. G06F 15/16; G06F 11/00

(52) U.S. Cl. 709/206; 709/224

(57) ABSTRACT

A system and machine-implemented method for determining a cost of an event is provided including detecting an initiation of an event, the event being associated with one or more intended participants, determining an estimated duration of the event and determining a total estimated cost of the event based on the estimated duration of the event and a cost per time unit for each of the one or more intended participants.

### BACKGROUND

The subject disclosure generally relates to events, and, in particular, to tracking cost of events.

Employees of an organization often schedule meetings with other employees by setting up and distributing a calendar invitation through a computer. Employees further communicate with other employees within the company through e-mail messages and mailing lists. It is possible that employees may schedule a meeting or start an e-mail message thread where the cost of holding the meeting or sending the e-mail message is disproportionate to the benefit gained from doing so.

However, typically, the employees are unaware of these costs and initiate meetings, e-mail threads or other types of interactions. Thus, tracking the cost of an event to encourage cost efficiency may be desirable.

### SUMMARY

The disclosed subject matter relates to a machine-implemented method for determining a cost of an event, the method comprising detecting an initiation of an event, the event being associated with one or more intended participants. The operations further comprising determining an estimated duration of the event and determining a total estimated cost of the event based on the estimated duration of the event and a cost per time unit for each of the one or more intended participants.

The disclosed subject matter also relates to a system for determining a cost of an event, the system comprising one or more processors and a machine-readable medium comprising instructions stored therein, which when executed by the processors, cause the processors to perform operations comprising detecting an initiation of an event, the event being associated with one or more intended participants. The operations further comprise determining an estimated duration of the event, determining an estimated cost per intended participant for the intended participant based on the estimated duration of the event and a cost per time unit for each of the one or more intended participants and determining a total estimated cost of the event based on the estimated cost per intended participant for the one or more intended participants.

The disclosed subject matter also relates to a machine-readable medium comprising instructions stored therein, which when executed by a machine, cause the machine to perform operations comprising detecting an initiation of an event, the event being associated with one or more intended participants. The operations further comprising determining an estimated duration of the event. The operations additionally comprising determining a total estimated cost of the event based on the estimated duration of the event and a cost per time unit for each of the one or more intended participants. The operations further comprising determining a probable participation fraction of the event, wherein the probable participation fraction corresponds to a fraction of the intended participants likely to participate in the event and adjusting the total estimated cost of the event to determine an adjusted cost of the event.

The disclosed subject matter further relates to a machine-implemented method for providing a user with an estimated meeting cost, the method comprising detecting an invitation for a meeting from a user, the invitation identifying a plurality of invitees and an estimated meeting duration. The method further comprising accessing and retrieving a cost per time unit for each of the plurality of invitees. The method further comprising determining a cost per invitee based on the cost per time unit for each respective invitee and the estimated meeting duration and determining a total estimated cost of the meeting, the total estimated cost of the meeting comprising a sum of the determined costs per invitee for all of the plurality of the invitees.

The disclosed subject matter further relates to a machine-implemented method for providing a user with an estimated e-mail message cost, the method comprising detecting a an e-mail message composed by a user, the e-mail message identifying one or more intended recipients. The method further comprising accessing and retrieving a cost per time unit for each of the one or more intended recipients. The method further comprising determining an estimated time spent per recipient for the e-mail message, the determining the estimated time spent per recipient comprising retrieving a pre-stored value of a time spent per content volume unit associated with the e-mail message and determining a volume content of the e-mail message and determining the estimated time spent per recipient based on the retrieved time spent per content volume unit and the content volume of the e-mail message. The method further comprising determining a cost per intended recipient for each of the one or more intended recipients based on the cost per time unit for the respective intended recipient and the estimated time spent per intended recipient and determining a total cost of the e-mail message, the total cost of the e-mail message comprising a sum of the costs per recipient for all of the one or more intended recipients.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for performing event cost estimation.

FIG. 2 illustrates a flow diagram of a process for determining an estimated cost for an event.

FIG. 3 illustrates a flow diagram of an exemplary process for determining an estimated cost of an e-mail message.

FIG. 4 illustrates a flow diagram of an exemplary process for determining an estimated cost for a meeting or other similar gathering.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As used herein, “event” refers to any form of activity (e.g., communication or gathering) involving more than one intended participant. Examples of events include an e-mail message, a meeting, a seminar, a conference (video, phone, etc.), a document collaboration or other forms of community-based activities having two or more intended participants (e.g., a mailing list or group of employees).

The disclosed subject matter provides a system for calculating a cost of an event being initiated by a user. The system further provides for displaying the calculated cost to the user such that the user can decide whether to continue with the event (e.g., sending the meeting invitation or electronic mail or sharing a document) based on whether doing so is cost efficient. The calculation of the cost of the event may occur once the system detects a user initiating the event or after the event has been initiated. For example, the cost initiation may occur as soon as enough information has been provided by the user to calculate an estimated cost of the event (e.g., during the time the user is composing an e-mail message, an invite to a meeting or a document collaboration invitation, but before the e-mail message or invite is sent and/or distributed). In another instance, the cost calculation may be performed after the event initiation has been completed (e.g., after sending an e-mail message or an invitation to one or more intended participants of the event).

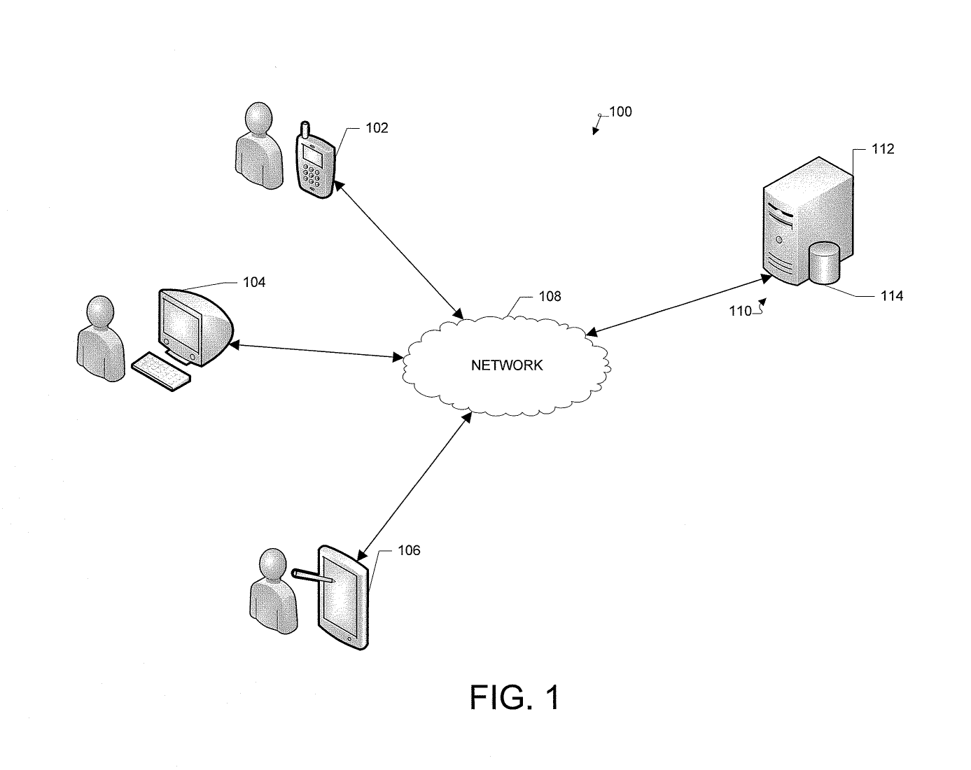

FIG. 1 illustrates an example client-server network environment which provides for performing event cost estimation. A network environment 100 includes a number of electronic devices 102-106 communicably connected to a server 110 by a network 108. Server 110 includes a processing device 112 and a data store 114. Processing device 112 executes computer instructions stored in data store 114, for example, to assist in estimating a cost for an event having intended participants including users operating electronic devices 102-106.

In some example embodiments, electronic devices 102-106 can be computing devices such as laptop or desktop computers, smartphones, PDAs, portable media players, tablet computers, or other appropriate computing devices that can be used to for communicating with intended participants of an event. In the example of FIG. 1, electronic device 102 is depicted as a smartphone, electronic device 104 is depicted as a desktop computer and electronic device 106 is depicted as a PDA.

In some example aspects, server 110 can be a single computing device such as a computer server. In other embodiments, server 110 can represent more than one computing device working together to perform the actions of a server computer (e.g., cloud computing). Furthermore, network 108 can be a public communication network (e.g., the Internet, cellular data network, dialup modems over a telephone network) or a private communications network (e.g., private LAN, leased lines). For example, in one embodiment, the network 108 may comprise a private LAN at an organization and users operating electronic devices 102-106 may be employees of the organization.

A user interacting with a client device (e.g., electronic devices 102-106) may initiate an event (e.g., a meeting, e-mail message, document collaboration), providing an indication of an expected duration of the event (e.g., an estimated meeting duration) and identifying the intended participants of the event. An event may be initiated when the user interacting with a client device composes and/or sends an e-mail message, shares an online document or sends an invitation or notification for a meeting, seminar, conference or other such community gathering to one or more intended participants. The e-mail message or event invitation may be formatted as an e-mail message, text e-mail message (e.g., SMS, MMS), or other similar format suitable for electronic communication. Similarly, documents may be shared within a cloud computing platform using e-mail messages or other document sharing or collaboration tools. Upon detecting the initiation of the event and the information entered by the user regarding the event, the system determines an expected duration of the event and identifies the intended participants of the event based on the information entered by the user (e.g., e-mail recipients, meetings invitees, recipients of an online document). The system may access a cost per time unit for each intended participant of the event (e.g., through server 110). The cost per time unit for each intended participant may be stored local to network 108 (e.g., at the data store 114) or remotely at a database accessible to the system (e.g., through server 110 and/or network 108). The system may then determine an estimated cost of the event based on the estimated duration of the event and the cost per time unit for the intended participants of the event.

The system may further have access to historical data regarding prior events related to the event being initiated by the user at a client device (e.g., electronic devices 102-106). The historical data may include information for determining a probable participation fraction of the event, which will be described in greater detail below. The system may access the historical data (e.g., through the server 110) and retrieve a probable participation fraction to determine an adjusted event cost, wherein the event cost is adjusted according to the historical data, including the probable participation fraction.

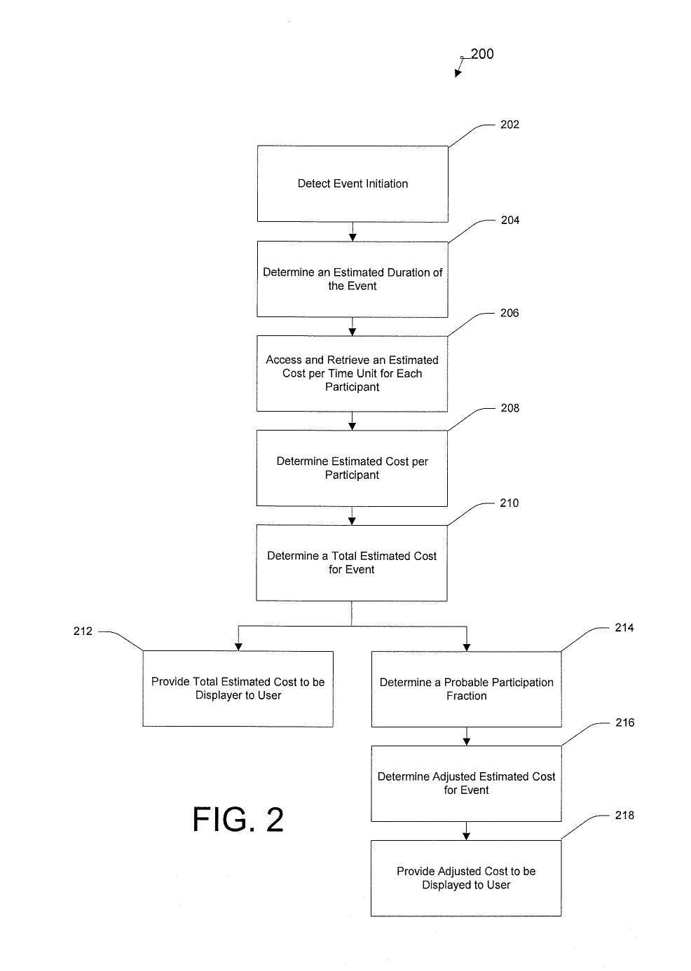

FIG. 2 illustrates a flow diagram of a process 200 for determining an estimated cost for an event. In step 202, the system detects an event initiated by a user. The event may include a communication such as an e-mail message, a document sharing/collaboration request, or an event invitation (e.g., a calendar invitation for a meeting), having one or more intended participants (e.g., recipients of the e-mail message, recipients of the document sharing/collaboration request, or invitees of the meeting). In step 204, the system determines an estimated duration of the event. The estimated duration of the event may provide an indication of the time it may take to read the context of the e-mail message (e.g., based on the volume of content within the e-mail message or the document being shared), or the duration of the meeting (e.g., as provided on the meeting invitation).

Next, in step 206, the system determines an estimated cost per time unit for each of the one or more intended participants. The cost per time unit for each of the one or more intended participants may be a monetary based cost per time unit. Alternatively, the cost per time unit for each participant may be expressed as a unit of time. The system may have access to pre-stored cost data regarding each intended participant (e.g., employee of an organization). Such data may include a monetary based cost per time unit for each intended participant (e.g., employee) and may be based upon the salary information for the intended participant (e.g., employee) as well as the overhead cost attributed to that intended participant (e.g., employee).

The salary information may include a periodic fixed salary (e.g., yearly, monthly, weekly), an hourly rate, bonuses and overtime costs, or any other salary related information that effects the potential cost of the time spent participating in the event. The salary information may be based on individualized actual salary for the intended participant (obtained with proper permissions), general salary information such as an average salary for all employees within an organization associated with the intended participant, a median salary of all employees of the organization, an average salary for the specific position held by the intended participant, the median salary for the specific position held by the intended participant, or any other value providing an indication of the potential cost of the intended participant taking part in the event. The system may access the salary information to determine the cost per time unit for each intended participant (e.g., employee). Alternatively, the cost per time unit for the intended recipients may be pre-calculated and accessible to the system.

In step 208, the system may determine an estimated cost for each intended participant. The determination is based on the estimated duration of the event determined in step 204 and the estimated cost per time unit for each intended participant, determined in step 206. Additionally, other considerations may be taken into account when determining the estimated cost for each intended participant. For example, the cost for the intended participant may be adjusted based on position, time of the event, estimated duration of the event, the workload of the intended participant, and other similar considerations which may effect the anticipated cost of the intended participant's taking part in the event. The estimated cost per intended participant may correspond to an amount of time spent per participant. Alternatively, the estimated cost for each intended participant may comprise a monetary based cost per participant (e.g., based on a monetary based cost per time unit per participant as determined in step 204).

Next, in step 210, the system determines a total estimated cost of the event. The total estimated cost may correspond to a monetary cost and may be determined based on the estimated cost of all intended participants, as determined in step 208. The total estimated cost may include the sum of the estimated cost per intended participant for all intended participants. The total estimated cost may be a weighted sum with the estimated cost for one or more of intended participants weighing more or less heavily in relation to the estimated cost of other intended participants for a variety of reasons. For example, certain intended participants may hold positions which make the anticipated cost of their involvement in the event higher such that their participation may usually be discouraged. However, their participation in certain events may be crucial or mandatory. To account for this, the total estimated cost of the event may be a weighted total taking into account variations in salary of the intended participants. Additionally, costs other than time related costs may also be taken into account when determining the total estimated cost of the event.

Alternatively, the total estimated cost may correspond to an amount of time spent by all participants. The amount of time spent by all participants may be determined based on the estimated duration of the event and the cost per time unit (corresponding to an amount of time) for each participant. The time spent may, for example, comprise the sum of the time spent per intended participant.

Once the system determines the total estimated cost of the event, in step 212, the system may provide the total estimated cost to be displayed to the user. The system may, for example, transmit the determined total estimated cost (e.g., through server 110) to the client device of the user initiating the event (e.g., electronic devices 102-106) to be displayed to the user. The total estimated costs may be displayed to the user, and the user may decide based on the cost to continue with the event, to modify the event (e.g., the estimated duration or intended recipients) or to terminate the event.

Furthermore and with proper permissions, the system may store the total estimated cost or may provide the total estimated cost of the event to a third party application for further processing or display to users. In one aspect, the event may be a reoccurring event (e.g., a weekly meeting), an event associated with other events (e.g., an e-mail message sent to a mailing list or an event invitation to a specific group) or may otherwise correspond to historical data accessible by the system that may indicate additional information the cost of the event. The historical data may include information regarding the intended participants and/or duration of previous events that are related to the event being initiated by the user.

In one aspect, the system may, upon determining a total estimated cost of the event, continue to step 214 and determine a probable participation fraction based on the historical data corresponding to the event. The system may identify historical data corresponding to the event based upon event characteristics such as event intended participants, event title, event purpose, the user initiating the event, date and time of event, and other event characteristics. The system may access the historical data to determine the probable participation fraction in step 214. For example, the historical data may include the probable participation fraction or enough data such that the system can calculate the probable participation fraction of the event (e.g., based on participation statistics for one or more past events corresponding to the event). The probable participation fraction may provide an indication of a fraction of the intended participants of the event likely to actually participate in the event. In one aspect, in addition to historical data, the probable participation fraction may further be determined based on the availability of the intended participants if such data is available to the system.

In step 216, the system may adjust the total estimated cost of the event based on the probable participation fraction to determine an adjusted cost of the event. The probable participation fraction may be used to provide a more accurate calculation of the cost of the meeting, taking into account that some intended participants may not actually participate in the event, and thus the estimated total cost of the event should be offset to reflect the number of intended participants likely to take part in the event. In one aspect, in addition to the probable participation fraction, the system may further have access to additional information (e.g., as part of the historical data or otherwise accessible information) to determine a probable duration of the event or other information regarding the actual settings of the event rather than what is estimated to occur. Thus, the system may further adjust the total estimated cost of the event based on the probable duration of the event and other indications determined by the system.

In step 218, the system may provide the adjusted cost of the event for display to the user. The system may, for example, transmit the determined adjusted cost (e.g., through server 110) to the client device of the user initiating the event (e.g., electronic devices 102-106) to be displayed to the user. The adjusted cost of the event may be displayed to the user, and the user may decide based on the displayed cost to continue with the event, to modify the event (e.g., the estimated duration or intended recipients) or to terminate the event.

With proper permissions, the system may also store the adjusted cost or may provide the adjusted cost of the event to a third party application or server for further processing or display to users. Process 200 may be performed locally through one or more servers (e.g., server 110) or may be performed entirely or in part at one or more third party servers and the determinations may then be used at the system for performing some or all steps of process 200.

The determination of the cost of the event (e.g., total estimated cost, or adjusted estimated time) may be performed once the user provides enough information to determine the estimated duration of the event and the intended participants for an event. The determination may occur either before or after the user has completed the initiation of the event (e.g., sending an e-mail message or event invitation).

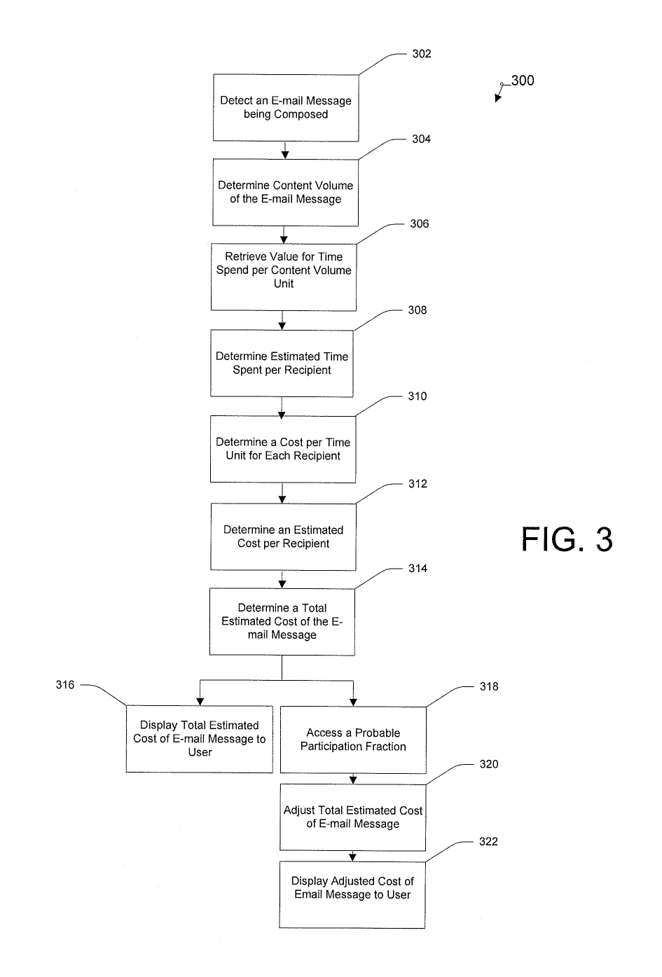

FIG. 3 illustrates a flow diagram of an exemplary process 300 for determining an estimated cost of an e-mail message. While the exemplary process refers specifically to e-mail messages, it should be understood by one skilled in the art that process 300 may be performed with respect to any form of communication between one or more users, devices and/or through one or more networks (e.g., text messages, e-mail messages).

In step 302, the system detects a user generating or sending an e-mail message. For example, a user interacting with a client device (e.g., electronic devices 102-106) may access an e-mail message application (e.g., an e-mail message application supported by the system) and may begin composing an e-mail message. The user may for example provide a list of intended participants for the e-mail message (hereinafter referred to as intended recipients) individually or as a mailing list having one or more intended recipients. The e-mail message may include a body including text and/or graphics and one or more attachments. The user may then press the send button to request that the e-mail message be transmitted to the one or more intended recipients. The system may detect the e-mail message being generated upon the user first requesting to compose the e-mail message, once the user selects to transmit the e-mail message or once the e-mail message is being transmitted for distribution (e.g., through server 110).

Upon detecting the e-mail message, the system may begin the process for determining an estimated time that each intended recipient is likely to spend on viewing, and/or replying to the e-mail message. In step 304, the system determines a content volume corresponding to the amount of content within the body of the e-mail message and/or any attachments included with the e-mail message. For example, the system may determine the number of words within the body and/or attachments of the e-mail message. Additionally, the system may detect the number and size of multimedia content included with the body or attachments of the e-mail message (e.g., audio content or video content, photos). Furthermore, the system may detect whether the e-mail message includes any links (e.g., links to web pages or other contents), and may further determine the content volume at the destination of those links included within the e-mail message.

Next, in step 306, the system determines an estimated time spent per content volume unit. The system may have access to information regarding the typical time it takes each recipient to view and/or reply to an e-mail message. Such information may for example include a time duration per word or per line of text within the body, a time duration for attachments (e.g., base on attachment size and/or type), a time duration per link (e.g., based on webpage size and/or webpage content), a duration per multimedia file (e.g., video or audio size, content or duration). In step 308, the determined content volume and estimated time spent per content volume unit may be used by the system to determine an estimated time that may be spent on the specific e-mail message by each intended recipient. For example, the estimated time per recipient may be determined by multiplying the content volume of the e-mail message by the estimated time spent per content volume for each intended recipient.

In step 310, the system determines a cost per time unit for each intended recipient. The cost per time unit for each participant may correspond to a unit of time. Alternatively, the cost per time unit for each of the one or more intended recipients may be a monetary based cost per time unit. The system may have access to pre-stored cost data regarding each intended recipient (e.g., employee of an organization). Such data may include a monetary based cost per time unit for each intended recipient (e.g., employee) and may be based upon the salary information for the intended recipient (e.g., employee) as well as the overhead cost attributed to that intended recipient (e.g., employee).

The salary information may include a periodic fixed salary (e.g., yearly, monthly, weekly), an hourly rate, bonuses and overtime costs, or any other salary related information that affects the potential cost of the time spent viewing or responding to the e-mail message. The salary information may be based on individualized actual salary for the intended recipient (with proper permissions), general salary information such as an average salary for all employees within an organization associated with the intended participant, a median salary of all employees of the organization, an average salary for the specific position held by the intended recipient, the median salary for the specific position held by the intended recipient, or any other value providing an indication of the potential cost of the intended recipient receiving, viewing or responding to the e-mail message. The system may access the salary information and determine the cost per time unit for each intended recipient (e.g., employee). Alternatively, the cost per time unit for the intended recipients may be pre-calculated and accessible to the system.

Next, in step 312, the system determines an estimated cost for each intended recipient of the e-mail message based on the determined estimated time spent per intended recipient on the e-mail message (determined in step 308) and the determined cost per time unit for each intended recipient (determined in step 310). For example, the estimated time spent per recipient on the e-mail message (determined in step 308) may be multiplied by the cost per time unit for each intended recipient (determined in step 310) to determine the estimated cost per intended recipient of the e-mail message.

The estimated cost for each intended participant may comprise a monetary based cost per participant (e.g., based on a monetary based cost per time unit per participant as determined in step 204). Alternatively, the estimated cost per intended participant may correspond to an amount of time spent per participant. The amount of time spent by each intended recipient may be determined based on the estimated time spent per intended recipient on the e-mail message (determined in step 308) and the cost per time unit (corresponding to a unit of time) for each participant.

In step 314, the system determines a total estimated cost for the e-mail message based on the estimated cost for all intended recipients, as determined in step 312. The total estimated cost may correspond to a monetary based cost and may include the sum of the estimated cost per intended participant for all intended recipients. The total estimated cost may be a weighted sum with the estimated cost for one or more of intended recipients weighing more or less heavily in relation to the estimated cost of other intended participants for a variety of reasons. For example, certain intended participants may hold positions which make the anticipated cost of their involvement in the event higher such that their participation may always be discouraged. However, their participation the e-mail thread may be crucial or mandatory. To account for this, the total estimated cost of the event may be a weighted sum taking into account variations in salary of the intended participants. Additionally, costs other than time related costs may also be taken into account when determining the total estimated cost for the e-mail message (e.g., the cost of distributing the e-mail message).

Alternatively, the total estimated cost of the e-mail message may correspond to an amount of time spent by all participants. For example, the total estimated cost of the e-mail message may be a sum of the amount of time spent by each of the intended recipients.

Once the system determines the total estimated cost for the e-mail message, in step 316 the system may provide the total estimated cost to be displayed to the user. The system may, for example, transmit the determined total estimated cost (e.g., through server 110) to the client device of the user generating the e-mail message (e.g., electronic devices 102-106) to be displayed to the user. The total estimated costs may be displayed to the user, and the user may decide based on the cost to continue with sending the e-mail message (or to continue with the distribution), to modify the e-mail message (e.g., the content volume or intended recipients) or to refrain from sending the e-mail message. Additionally or alternatively, the system may store the total estimated cost of the e-mail message and/or may provide the total estimated cost for the e-mail message to a third party application for further processing or display to users.

In one aspect, the system may have access to historical data corresponding to the e-mail message (e.g., regarding the recipients, e-mail message list, subject, or other indication within the e-mail message) that indicate additional information regarding the cost of the e-mail message (e.g., information regarding the recipients or content of the e-mail message).

The system may access the historical data to determine a probable participation fraction in step 318. In one aspect, the system may, upon determining a total estimated cost for the e-mail message, continue to step 318 and determine a probable participation fraction, referring to the number of the intended recipients likely to read all or some of the e-mail message. For example, the historical data may for example include the probable participation fraction or enough data such that the system can calculate the probable participation fraction for the e-mail message (e.g., based on participation statistics for one or more e-mail messages sent to same or similar recipients, having the same or similar subject and/or similar content). The probable participation fraction may provide an indication of a fraction of the intended recipients of the e-mail message likely to view the e-mail message or a part thereof. In one aspect, in addition to historical data, the probable participation fraction may further be determined based on the availability of the intended recipients if such data is available to the system. The system may identify historical data corresponding to the e-mail message based upon information such as the intended recipients, the user initiating the e-mail message, the subject of the e-mail message, the content of the e-mail message and other similar e-mail message related information.

In step 320, the system may adjust the total estimated cost of the event based on the probable participation fraction to determine an adjusted cost of the e-mail message. The probable participation fraction may be used to provide a more accurate calculation of the cost of the e-mail message, taking into account that some intended recipients may not actually open, view and/or respond to the e-mail message/thread, and thus the estimated total cost of the e-mail message should be offset to reflect the number of intended recipients likely to spend time viewing the e-mail message.

In step 322, the system may provide (e.g., transmit) the adjusted cost of the event for display to the user. The system may, for example, transmit the determined adjusted cost (e.g., through server 110) to the client device of the user initiating the e-mail message (e.g., electronic devices 102-106) to be displayed to the user. The adjusted costs of the e-mail message may be displayed to the user, and the user may decide based on the cost to continue with sending the e-mail message, to modify the e-mail message (e.g., the content of the e-mail message or intended recipients) or to terminate the e-mail message

Additionally, with proper permissions, the system may store the adjusted cost or may provide the adjusted cost of the e-mail message to a third party application or server for further processing or display to users. Process 300 may be performed locally through one or more servers (e.g., server 110) or may be performed entirely or in part at one or more third party servers and the determinations may then be used at the system for performing some or all steps of process 300.

The above cost calculations of the e-mail message may be performed for users of client devices (e.g., electronic devices 102-106) initiating a new e-mail message or recipients of the e-mail message who wish to reply to the e-mail message or forward the e-mail message to other recipients. The determination of the cost of the e-mail message (e.g., total estimated cost, or adjusted estimated time) may be performed once the user provides enough information to determine the estimated time spent on the e-mail message and the intended recipients of the e-mail message. The determination may occur either before or after the user has completed sending the e-mail message.

As described above, while the exemplary process 300 refers specifically to e-mail messages, it should be understood by one skilled in the art that process 300 may be performed with respect to any form of communication between one or more users, devices and/or through one or more networks (e.g., text messages, e-mail messages, document collaboration requests).

For example, similar calculations may be performed for sharing documents with one or more recipients through a cloud based computing platform. In such instances, the documents may be shared as an attachment to an e-mail message or may be shared using a link within an e-mail message or through other document sharing/collaboration mechanism. Upon detecting a request to share the document (e.g., similar to step 302 of process 300), The content volume of the document sharing/collaboration request may be calculated similar to calculating the content volume of documents attached to e-mail messages in step 304 (e.g., using the number of words, links or multimedia content and/or the size of the document to calculate a content volume). Accordingly, the content volume of the document may be determined based on one or more of the number of words within the document, a size and number of multimedia content within the document, the number of links and the size of the destination of those links, or a size of the document. The content volume of the document may then be used to calculate the cost of the document sharing/collaboration with one or more intended recipients according to steps 306-322 of process 300 described above for calculating the cost of an e-mail message.

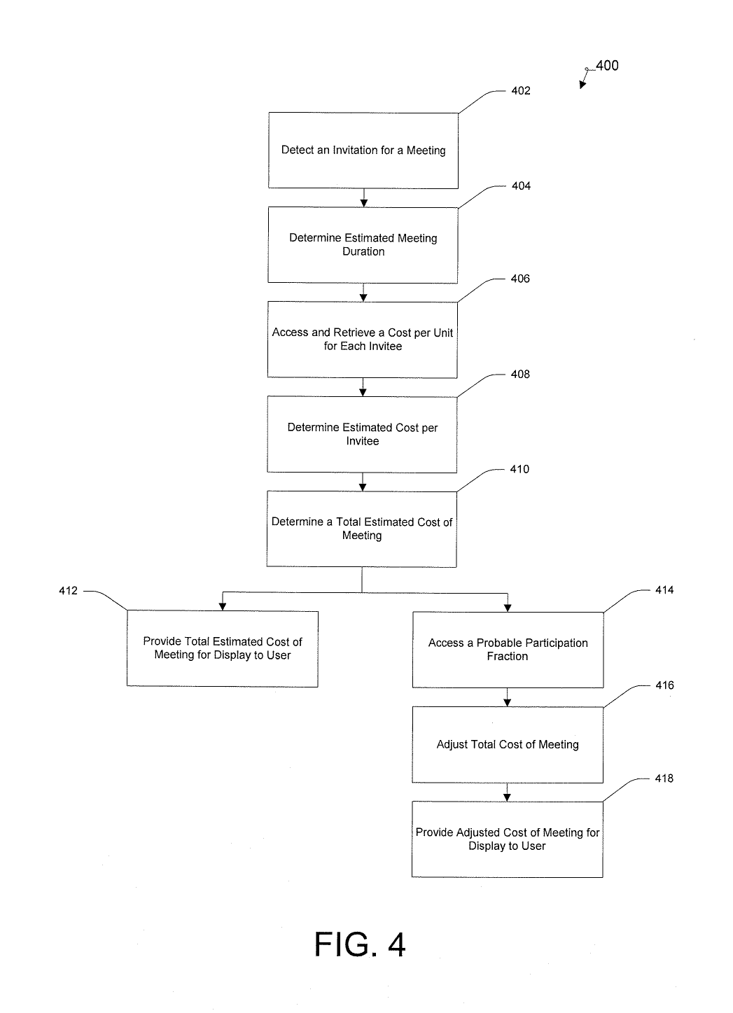

FIG. 4 illustrates a flow diagram of an exemplary process 400 for determining an estimated cost for a meeting or other similar gathering. In step 402, the system detects an invitation for a meeting (event) initiated by a user (e.g., at a client device). The meeting invitation (e.g., a calendar invitation for a meeting), may have one or more intended participants (hereinafter referred to as invitees) specified by the user. In step 404, the system determines an estimated meeting duration for the meeting (e.g., provided by the user on the invitation).

Next, in step 406, the system determines an estimated cost per time unit for each of the invitees. The cost per time unit for each invitee may be a monetary based cost per time unit. Alternatively, the cost per time unit for each invitee may correspond to a unit of time. The system may have access to pre-stored cost data regarding each invitee (e.g., employee of an organization). Such data may include the monetary based cost per time unit for each invitee (e.g., employee) and may be based upon the salary information for the invitees (e.g., employee) as well as the overhead cost attributed to that invitee (e.g., employee).

The salary information may include a periodic fixed salary (e.g., yearly, monthly, weekly), an hourly rate, bonuses and overtime costs, or any other salary related information that affects the potential cost of the time spent by the invitee participating in the meeting. The salary information may be based on individualized actual salary for the invitee (with proper permissions), or general salary information such as an average salary for all employees within an organization associated with the invitee, a median salary of all employees of the organization, an average salary for the specific position held by the invitee, or the median salary for the specific position held by the invitee, or any other value providing an indication of the potential cost of the invitee participating in the meeting. The system may access the salary information and determine the cost per time unit for each invitee (e.g., employee). Alternatively, the cost per time unit for the invitees may be pre-calculated and accessible to the system.

In step 408, the system determines an estimated cost of the participation of the invitee in the meeting for each invitee based on the estimated duration for the meeting, determined in step 404, and the estimated cost per time unit for each invitee, as determined in step 406. The estimated cost for each invitee may correspond to an amount of time spent per invitee. Alternatively, the estimated cost for each invitee may comprise a monetary based cost (e.g., based on a monetary based cost per time unit per invitee as determined in step 404). Additionally, other considerations may be taken into account when determining the estimated cost for each invitee. For example, the cost for the invitee may be adjusted based on position, time of the event, estimated duration of the event, the workload of the invitee, and other similar considerations which may effect the anticipated cost of the invitee taking part in the event.

In step 410, the system determines a total estimated cost for the meeting. The total estimated cost may include the sum of the estimated cost per invitee for all invitees. The total estimated cost may be a weighted sum with the estimated cost for one or more of invitees weighing more or less heavily in relation to the estimated cost of other invitees for a variety of reasons. For example, certain invitees may hold positions which make the anticipated cost of their involvement in the event higher such that their participation may typically be discouraged. However, their participation in certain meetings may be crucial or mandatory. To account for this, the total estimated cost of the event may be a weighted total taking into account variations in salary of the invitees. Additionally, costs other than time related costs may also be taken into account when determining the total estimated cost of the event.

Alternatively, the total estimated cost of the meeting may correspond to an amount of time spent by all invitees determined based on the estimated duration of the meeting and the cost per time unit (corresponding to an amount of time) for each invitee. The time spent may, for example, be the sum of the time spent per invitee for all invitees.

Once the system determines the total estimated cost for the meeting, in step 412, the system may provide the total estimated cost to be displayed to the user. The total estimated cost may be displayed to the user, and the user may decide based on the cost to continue with the meeting (e.g., send out the invite), to modify the meeting invitation and/or meeting (e.g., the estimated duration or invitees of the meeting) or to terminate the meeting and/or meeting invitation. The system may, for example, transmit the determined total estimated cost (e.g., through server 110) to the client device of the user creating the meeting invitation (e.g., electronic devices 102-106) to be displayed to the user.

Additionally, with proper permissions, the system may store the total estimated cost or may provide the total estimated cost for the meeting to a third party application for further processing or display to users. In one aspect, the meeting may be a reoccurring meeting (e.g., a weekly meeting), or a meeting similar to or associated with other meetings (e.g., a meeting taking place between to a specific project group) or may otherwise correspond to historical data accessible by the system that indicate additional information regarding the cost of the meeting.

The system may access the historical data to determine a probable participation fraction for the meeting in step 414. In one aspect, the system may, upon determining a total estimated cost for the meeting, continue to step 414 and determine a probable participation fraction based on the historical data corresponding to the meeting including for example information regarding the intended participants and duration of previous meetings similar to the meeting being scheduled by the user.

The system may identify historical data corresponding to the meeting based upon meeting related information such as the invitees, meeting title, meeting purpose, the user sending out the invite, date and time of the meeting, and other similar meeting characteristic information. The historical data may for example include the probable participation fraction or enough data such that the system can calculate the probable participation fraction for the meeting (e.g., based on participation statistics for one or more other meetings similar to the current meeting). The probable participation fraction provides an indication of a fraction of the invitees likely to actually attend the meeting. In one aspect, in addition to historical data, the probable participation fraction may further be determined based on the availability of the invitees if such data is available to the system (e.g., based on the calendar of the invitees).

In step 416, the system may adjust the total estimated cost of the meeting based on the probable participation fraction to determine an adjusted cost of the meeting. The probable participation fraction may be used to provide a more accurate calculation of the cost of the meeting, taking into account that some invitees (i.e., intended participants) may not actually attend the meeting, and thus the estimated total cost of the event should be offset to reflect the number of invitees likely to take part in the meeting. In one aspect, in addition to the probable participation fraction, the system may further have access to additional information (e.g., as part of the historical data or otherwise accessible information) to determine a probable duration of the meeting or other information regarding the actual settings of the meeting rather than what is estimated to occur. The system may further adjust the total estimated cost of the event based on the probable duration of the meeting and/or other indications of the actual participation or duration determined by the system.

In step 418, the system may provide (e.g., transmit) the adjusted cost of the event for display to the user. The system may, for example, transmit the determined adjusted cost (e.g., through server 110) to the client device of the user initiating the event (e.g., electronic devices 102-106) to be displayed to the user. The adjusted cost of the meeting may be displayed to the user, and the user may decide based on the cost to continue with the meeting, to modify the meeting (e.g., the estimated duration or invitees) or to terminate the meeting and/or meeting invitation.

Additionally, with proper permissions, the system may store the adjusted cost or may provide the adjusted cost of the meeting to a third party application or server for further processing or display to users. Process 400 may be performed locally through one or more servers (e.g., server 110) or may be performed entirely or in part at one or more third party servers and the determinations may then be used at the system for performing some or all steps of process 400.

The determination of the cost of the meeting (e.g., total estimated cost, or adjusted estimated time) may be performed once the user provides enough information to determine the estimated duration of the meeting and the intended participants (invitees) of the meeting. The determination may occur either before or after the user has sent the event invitation.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

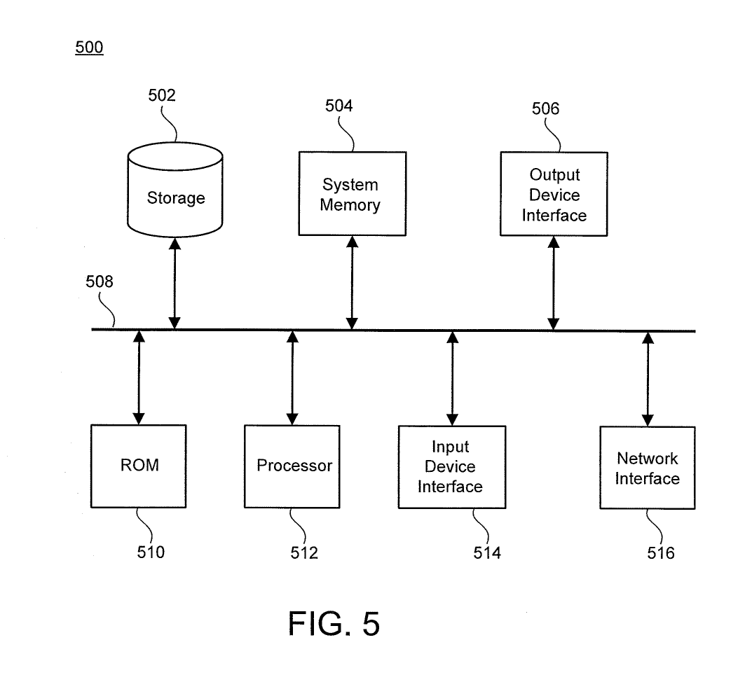

FIG. 5 conceptually illustrates an electronic system with which some implementations of the subject technology are implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for tracking estimated costs of events in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for determining a cost of an event, the method comprising:
detecting initiation of an event, the event being associated with one or more intended participants;
determining an estimated duration of the event; and
determining a total estimated cost of the event based on the estimated duration of the event and a cost per time unit for each of the one or more intended participants.

2. The method of claim 1, further comprising providing the total estimated cost of the event to be displayed to the user.

3. The method of claim 1, further comprising:
determining a probable participation fraction of the event, wherein the probable participation fraction corresponds to a fraction of the one or more intended participants likely to participate in the event; and
adjusting the total estimated cost of the event to determine an adjusted cost of the event.

4. The method of claim 3, wherein the determining the probable participation fraction of the event comprises:
accessing historical data corresponding to the event based on event-related information; and
determining the probable participation fraction of the event based on the historical data.

5. The method of claim 4, wherein the event-related information comprises at least one of the one or more intended participants, an event time, an event date, an event location, an event subject, or an event organizer.

6. The method of claim 1, wherein the event comprises an e-mail message, and wherein the one or more intended participants comprise one or more intended recipients of the e-mail message.

7. The method of claim 6, wherein the determining the estimated duration of the event comprises:
determining a content volume of the e-mail message;
determining a predefined time spent per content volume unit for the e-mail message; and
determining an estimated time spent on the e-mail message based on the content volume of the e-mail message and the predefined time spent per content volume unit for the e-mail message, wherein the estimated duration of the event comprises the estimated time spent on the e-mail message.

8. The method of claim 7, wherein the content volume of the e-mail message comprises at least one of a number of words within the body of the e-mail message, a size and number of multimedia content within the body of the e-mail message, a number of attachments of the e-mail message, or a size of the attachments of the e-mail message.

9. The method of claim 1, wherein the event comprises a meeting, and wherein the one or more intended participants comprise one or more invitees specified in an invitation to the meeting.

10. The method of claim 1, wherein the event comprises a request to share a document, and wherein the one or more intended participants comprise one or more intended recipients of the document.

11. The method of claim 10, wherein the determining the estimated duration of the event comprises:
determining a content volume of the document;
determining a predefined time spent per content volume unit for the document; and
determining an estimated time spent on the document based on the content volume of the document and the predefined time spent per content volume unit for the document, wherein the estimated duration of the event comprises the estimated time spent on the document.

12. The method of claim 11, wherein the content volume of the document comprises at least one of a number of words of the document, a size and number of multimedia content within the document, or a size of the document.

13. The method of claim 1, wherein the cost per time unit for each of the one or more intended participants is determined based on a cost based monetary amount associated with each intended participant as a function of time.

14. The method of claim 13, wherein the cost based monetary amount is determined based on salary information associated with each intended participant, wherein the salary information for each intended participant comprises at least one of individualized actual salary for the intended participant, an average salary within an organization associated with the intended participant, a median salary within the organization associated with the intended participant, an average salary for a specific position held by the intended participant, or a median salary for the specific position held by the intended participant.

15. The method of claim 1, further comprising:
determining an estimated cost of the event for each of the one or more intended participants of the event based on the estimated duration of the event and a cost per time unit for the intended participant,
wherein the total estimated cost of the event comprises a sum of the estimated cost of the event for the one or more intended participants.

16. A system for determining a cost of an event, the system comprising:
one or more processors; and
a machine-readable medium comprising instructions stored therein, which when executed by the processors, cause the processors to perform operations comprising:
detecting an initiation of an event, the event being associated with one or more intended participants;
determining an estimated duration of the event;
determining an estimated cost per intended participant for each of the one or more intended participants based on the estimated duration of the event and a cost per time unit for the intended participant; and
determining a total estimated cost of the event based on the estimated cost per intended participant for the one or more intended participants.

17. The system of claim 16, the operations further comprising:
determining a probable participation fraction of the event, wherein the probable participation fraction corresponds to a fraction of the one or more intended participants likely to participate in the event; and
adjusting the total estimated cost of the event to determine an adjusted cost of the event.

18. The method of claim 17, further comprising providing the adjusted cost of the event to be displayed to the user.

19. A machine-readable medium comprising instructions stored therein, which when executed by a machine, cause the machine to perform operations comprising:
detecting an initiation of an event, the event being associated with one or more intended participants;
determining an estimated duration of the event;
determining a total estimated cost of the event based on the estimated duration of the event and a cost per time unit for each of the one or more intended participants;
determining a probable participation fraction of the event, wherein the probable participation fraction corresponds to a fraction of the intended participants likely to participate in the event; and
adjusting the total estimated cost of the event to determine an adjusted cost of the event.

20. The machine-readable of claim 19, the operations further comprising providing the adjusted cost of the event to be displayed to the user.

21. A method for providing a user with an estimated meeting cost, the method comprising:
detecting an invitation for a meeting, the invitation identifying a plurality of invitees and an estimated meeting duration;
accessing and retrieving a cost per time unit for each of the plurality of invitees;
determining a cost per invitee based on the cost per time unit for each respective invitee and the estimated meeting duration; and
determining a total estimated cost of the meeting, the total estimated cost of the meeting comprising a sum of the determined costs per invitee for the plurality of invitees.

22. The method of claim 21, further comprising:
accessing a pre-stored value indicating a probable participation fraction, wherein the probable participation fraction indicates a fraction of the plurality of invitees likely to attend the meeting;
adjusting the total estimated cost of meeting by the probable participation fraction to generate an adjusted cost of the meeting; and
providing the adjusted cost of the meeting to be displayed the user.

23. A method for providing a user with an estimated e-mail message cost, the method comprising:
detecting a an e-mail message, the e-mail message identifying one or more intended recipients;
accessing and retrieving a cost per time unit for each of the one or more intended recipients;
determining an estimated time spent per recipient for the e-mail message, the determining the estimated time spent per recipient comprising:
retrieving a pre-stored value of a time spent per content volume unit associated with the e-mail message; and
determining a volume content of the e-mail message; and
determining the estimated time spent per recipient based on the retrieved time spent per content volume unit and the content volume of the e-mail message;
determining a cost per intended recipient for each of the one or more intended recipients based on the cost per time unit for the respective intended recipient and the estimated time spent per intended recipient; and
determining a total cost of the e-mail message, the total cost of the e-mail message comprising a sum of the costs per recipient for the one or more intended recipients.

24. The method of claim 23, further comprising providing the total estimated cost of the e-mail message to be displayed to the user.

25. The method of claim 23, further comprising:
accessing a pre-stored value indicating a probable participation fraction, wherein the probable participation fraction indicates a fraction of the one or more intended recipients likely to view the e-mail message;
adjusting the total estimated cost of the e-mail message based on the probable view fraction to generate an adjusted cost of the e-mail message; and
providing the adjusted cost of the e-mail message to be displayed to the user.
